(19) United States
(12) Patent Application Publication
(10) Pub. No.: US 2013/0028463 A1
(43) Pub. Date: Jan. 31, 2013

(54) LOUDSPEAKER ASSEMBLY

(71) Applicant: Dominic Baker, London (GB)

(72) Inventor: Dominic Baker, London (GB)

(73) Assignee: AUDIO PARTNERSHIP PLC, London (GB)

(21) Appl. No.: 13/528,572

(22) Filed: Jun. 20, 2012

(30) Foreign Application Priority Data
Jul. 26, 2011 (GB) 1112847.7

(51) Int. Cl. H04R 1/02

(52) U.S. Cl. 381/391

(57) ABSTRACT

A loudspeaker assembly comprising: a mounting part configured to be mounted in an opening in a wall or ceiling; an electro-acoustic driver unit for connection to the mounting part; and a grille for covering at least a part of the electro-acoustic driver unit from view when the loudspeaker assembly is installed in a wall or ceiling; wherein the electro-acoustic driver unit comprises an integral mounting surface for attaching the grille to the loudspeaker assembly.

### CROSS-REFERENCE TO RELATED APPLICATION

This application claims the benefit of the filing date of United Kingdom Patent Application GB 1112847.7, filed Jul. 26, 2011 and entitled “Loudspeaker Assembly,” the disclosure of which is hereby incorporated herein by this reference in its entirety.

### TECHNICAL FIELD

The present invention relates to a loudspeaker assembly for mounting in an opening (e.g., blind opening) in a wall or ceiling or the like.

### BACKGROUND

It is well known in the art to provide loudspeaker assemblies comprising a mounting part for mounting in a wall (e.g., stud wall) or ceiling and an electro-acoustic driver unit for attaching to the mounting part. A grille for covering the electro-acoustic driver unit (e.g., to protect the electro-acoustic driver unit and to obscure the electro-acoustic driver unit from view) is typically attached to a mounting ring configured for connection to the mounting part. The grille may be provided in a color configured to blend in with the wall or ceiling in which the loudspeaker assembly is to be mounted.

U.S. Pat. No. 7,543,681 discloses an architectural loudspeaker assembly in which the grille is magnetically mounted to the mounting ring in order to provide a loudspeaker assembly of reduced profile relative to other prior art systems.

### BRIEF SUMMARY

The present applicant has appreciated the need for an improved loudspeaker assembly capable of providing additional advantages of the prior art.

In accordance with a first aspect of the present invention, there is provided a loudspeaker assembly comprising: a mounting part configured to be mounted in an opening (e.g., blind opening) in a wall or ceiling; an electro-acoustic driver unit for connection to the mounting part; and a grille for covering at least a part of the electro-acoustic driver unit from view when the loudspeaker assembly is installed in a wall or ceiling; wherein the electro-acoustic driver unit comprises an integral mounting surface for attaching the grille to the loudspeaker assembly e.g., to the mounting part or to the electro-acoustic driver unit).

In this way, an in-wall/in-ceiling loudspeaker assembly is provided in which the grille is directly attached to the drive unit (i.e., with the drive unit forming the front cosmetic trim of the loudspeaker assembly when the grille is removed), thereby allowing the profile of the loudspeaker assembly to be reduced relative to prior art assemblies requiring use of a separate mounting ring. Furthermore, a reduced number of components are required for the assembly, thereby reducing cost and impact on the environment.

The mounting part (either alone or in combination with the electro-acoustic driver unit) may be configured to clamp the loudspeaker assembly to the wall or ceiling. For example, the mounting part may comprise a body and an arm mounted on the body, the arm having a portion, which after insertion into the opening, is movable from an inoperative position substantially aligned with the body to an operative position substantially spaced from and projecting to one side of the body for bearing against a surrounding wall or ceiling surface.

The integral mounting surface may define an attachment point for attaching the grille to the loudspeaker assembly (e.g., to the mounting part or to the electro-acoustic driver unit). The attachment point may be located on or accessible through the integral mounting surface.

In one embodiment, the integral mounting surface is provided by an integral flange extending around a drive axis of the electro-acoustic drive unit. In the case of an electro-acoustic drive unit having a circular cross-sectional profile, the integral flange may extend circumferentially around the drive axis.

In one embodiment, the mounting part defines a further flange for abutting an outer surface of the wall or ceiling. The integral flange and the further flange may be configured to at least partially overlap. In one embodiment, the integral flange is configured to substantially cover the further flange when the electro-acoustic driver unit is connected to the mounting part.

In one embodiment, the integral flange defines one or more recesses for receiving a magnet (e.g., permanent magnet). The grille may comprise a magnetically attractable part (e.g., formed from a magnetically attractable material such as a ferromagnetic metal).

Each recess may comprise an aperture extending through the integral flange. In the case of a loudspeaker assembly comprising a further flange, the magnet may be attached (e.g., glued) to the further flange.

In one embodiment, the mounting part defines a substantially sealed enclosure for the electro-acoustic driver unit. In addition or alternatively, at least one of the mounting part and the integral flange are formed from a metallic material (e.g., pressed steel). In this way, the loudspeaker assembly may be configured to meet any applicable building regulations for fire or noise.

In accordance with a second aspect of the present invention, there is provided a loudspeaker assembly comprising: a mounting part configured to be mounted in an opening (e.g., blind opening) in a wall or ceiling; an electro-acoustic driver unit for connection to the mounting part; and a grille for covering at least part of the electro-acoustic driver unit from view when the loudspeaker assembly is installed in a wall or ceiling; wherein the mounting part comprises a mounting surface for attaching the grille to the mounting part.

In one embodiment, the mounting surface is provided by a flange (e.g., integral flange) for abutting an outer surface of the wall or ceiling.

### BRIEF DESCRIPTION OF THE DRAWINGS

An embodiment of the present invention will now be described with reference to the following drawings in which:

FIG. 1A is an exploded rear perspective view of an apparatus in accordance with an embodiment of the present invention; and

FIG. 1B is a an exploded front perspective view of the apparatus of FIG. 1A.

FIGS. 1A and 1B show an in-wall/in-ceiling loudspeaker assembly 10, comprising: a mounting part 20 configured to be mounted in a blind opening in a wall or ceiling; an electro-acoustic driver unit 30 for connection to the mounting part 20; and a grille 40 for covering at least a part of the electro-acoustic driver unit 30 from view when the loudspeaker assembly 10 is installed in a wall or ceiling.

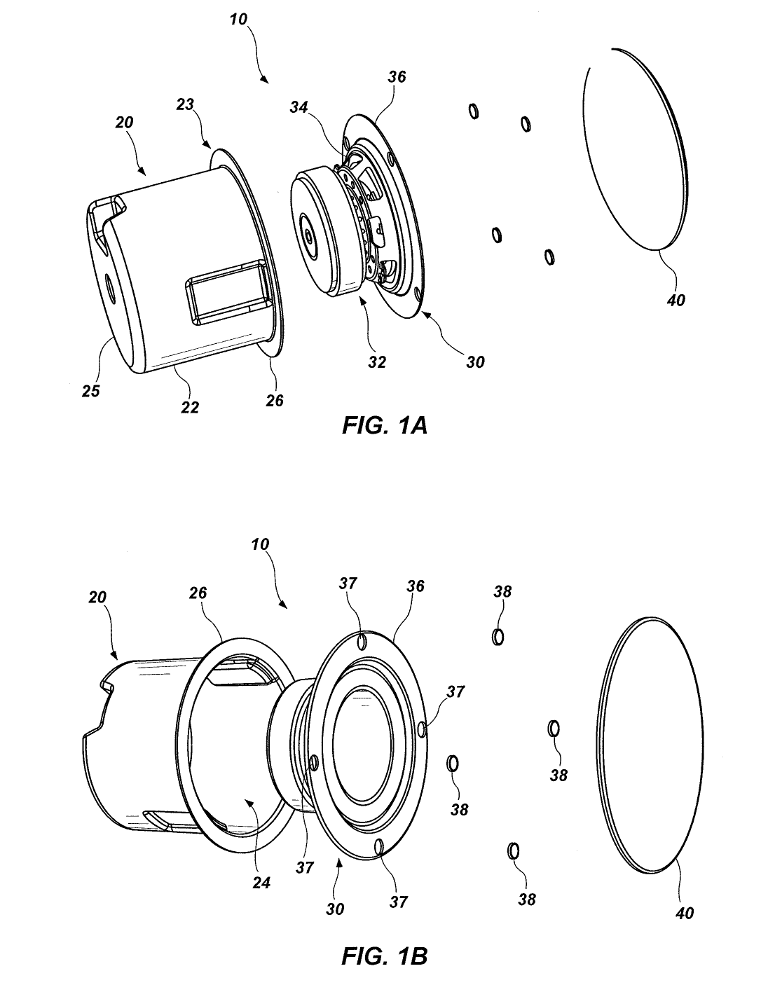

### DETAILED DESCRIPTION

Mounting part 20 comprises a substantially cylindrical body (or can) 22 having a first end 23 defining an opening 24 for receiving electro-acoustic driver unit 30 and a second end 25 that is closed to define a sealed chamber for receiving rearward sound generated by the electro-acoustic driver unit 30. Mounting part 20 further comprises a circumferentially extending flange 26 for abutting an outer surface of the wall or ceiling in order to clamp (in combination with a movable arm (not shown) configured to be urged against an inner surface of the wall) mounting part 20 to a wall or ceiling in combination. Cylindrical body 22 and flange 26 are each formed from pressed steel in order to define a sealed, fire-proof enclosure.

Electro-acoustic driver unit 30 is connected to mounting part 20 by a connection mechanism (not shown). Electro-acoustic driver unit 30 comprises an electromagnetic driver 32 including a frame (or basket) 34 (also formed from pressed steel) comprising an integral flange 36 extending circumferentially around a drive axis of the driver 32 to define an integral mounting surface for attaching grille 40 to electro-acoustic driver unit 30. Integral flange 36 defines a plurality of equally circumferentially spaced apertures 37 (four spaced by 90 degrees in the embodiment illustrated) for snugly receiving permanent magnets 38 which are in turn glued to flange 26 of mounting part 20.

Grille 40 is formed from a magnetically attractable material (e.g., ferromagnetic material) and is held in place by magnets 38.

In this way, an in-wall/in-ceiling loudspeaker assembly 10 is provided in which the grille is directly attached to electro-acoustic drive unit 30, thereby allowing the profile of the loudspeaker assembly and number of components to be reduced relative to prior art assemblies requiring use of a separate mounting ring. Furthermore, the provision of a sealed mounting part 20 formed from steel allows the loudspeaker assembly 10 to meet applicable building regulations for fire or noise.

1. A loudspeaker assembly, comprising:
a mounting part configured to be mounted in an opening in a wall or ceiling;
an electro-acoustic driver unit for connection to the mounting part; and
a grille for covering at least a part of the electro-acoustic driver unit from view when the loudspeaker assembly is installed in a wall or ceiling;
wherein the electro-acoustic driver unit comprises an integral mounting surface for attaching the grille to the loudspeaker assembly.

2. The loudspeaker assembly of claim 1, wherein the integral mounting surface is provided by an integral flange extending around a drive axis of the electro-acoustic driver unit.

3. The loudspeaker assembly of claim 2, wherein the mounting part defines a further flange for abutting an outer surface of the wall or ceiling.

4. The loudspeaker assembly of claim 3, wherein the integral flange and the further flange are configured to at least partially overlap.

5. The loudspeaker assembly of claim 4, wherein the integral flange is configured to substantially cover the further flange when the electro-acoustic driver unit is connected to the mounting part.

6. The loudspeaker assembly of claim 1, wherein the integral flange defines one or more recesses for receiving a magnet and the grille comprises a magnetically attractable part.

7. The loudspeaker assembly of claim 6, wherein the one or more recesses comprise an aperture extending through the integral flange.

8. The loudspeaker assembly of claim 7, wherein the magnet is attached to the further flange.

9. The loudspeaker assembly of claim 1, wherein the mounting part defines a substantially sealed enclosure for the electro-acoustic driver unit.

10. The loudspeaker assembly of claim 1, wherein at least one of the mounting part and the integral flange are formed from a metallic material.

11. A loudspeaker assembly, comprising:
a mounting part configured to be mounted in an opening in a wall or ceiling;
an electro-acoustic driver unit for connection to the mounting part; and
a grille for covering at least part of the electro-acoustic driver unit from view when the loudspeaker assembly is installed in a wall or ceiling;
wherein the mounting part comprises a mounting surface for attaching the grille to the mounting part.

12. The loudspeaker assembly of claim 11, wherein the mounting surface is provided by a flange for abutting an outer surface of the wall or ceiling.
